(19) United States
(12) Patent Application Publication
(10) Pub. No.: US 2006/0165558 A1
(43) Pub. Date: Jul. 27, 2006

(54) Cartridge for diagnostic assays

(76) Inventors: Thomas Witty, Santa Cruz, CA (US); Scott Castanon, San Marcos, CA (US)

Correspondence Address: HELLER EHRMAN LLP, 275 MIDDLEFIELD ROAD, MENLO PARK, CA, 94025-3506, US

(21) Appl. No.: 11/313,288

(22) Filed: Dec. 19, 2005

Related U.S. Application Data
(60) Provisional application No. 60/638,849, filed on Dec. 21, 2004.

(51) Int. Cl. B01L 3/00

(52) U.S. Cl. 422/58; 422/102

(57) ABSTRACT

A cartridge is provided for receiving a sample, including but not limited to blood, urine, and the like. The cartridge includes an input port or dock for receiving a sample from a sample container. A first chamber is in fluid communication with the input port. A flow cell is in fluid communication with the first chamber. The flow cell contains at least one reagent. The reagent can be a calibrant, a fluid containing reactant, a fluid not containing a reactant, a sample, and the like. A pressure port is configured to be coupled to a pressure source, including but not limited to a syringe pump, and the like. A vent port is also provided. The cartridge is configured to maintain fluids in a sealed manner.

### CROSS-REFERENCE TO RELATED APPLICATIONS

This application claims the benefit of U.S. Ser. No. 60/638,849, filed Dec. 21, 2004, which application is incorporated herein by reference in its entirety.

### BACKGROUND OF THE INVENTION

1. Field of the Invention

This invention relates generally to diagnostic assays, and more particularly to cartridge used for the collection and processing of samples in diagnostic assays.

2. Description of the Related Art

The ability to measure quantitatively a wide variety of physiologically active compounds is important as an adjunct to diagnosis and therapy. The medical industry has become increasingly dependent on the ability to measure various entities in physiological fluids in order to determine the health status of an individual, dosage level for drugs, use of illegal drugs, genomic sequences and the like.

Diagnostic assays of biological samples for one or more analytes typically required clinical laboratory determinations. However, there has been an increasing focus on being able to carry out assay determinations in the doctor's office and in the home.

Blood is often the source of a sample to diagnose a patient's health or to monitor the efficacy of drugs that have been administered to the patient. There are many difficulties using blood such as, rapid coagulation, the presence of a large number of light absorbing and fluorescent substances, variations in composition, susceptibility to changes in relation to reagents used in assays, and variations In the presence or absence of oxygen. Number methods have been used to reduce the effects of these difficulties such as, high dilution, addition of anticoagulants and separation of blood into plasma and its cellular components.

Often, a blood collection container such as a vacuum tube or syringe is used. The delivery of the sample into the assay requires the transfer of blood from the collection container to an assay device. The transfer increases the risk of both hazardous contact to the clinician as well as alteration of the specimen.

Various photometers are commercially available for measuring the light absorbance of liquid samples in microtitration plates or other sample holding vessels. Examples of such equipment are the MR 600 Microplate Reader (Dynatech Laboratories, Inc., Alexandria, Va.), and the Vmax Kinetic Microplate Reader (Molecular Devices, Palo Alto, Calif.).

There is a need for improved diagnostic assay devices of biological samples. There is a further need for an improved cartridge to obtain and provide a place for sample analysis.

### SUMMARY OF THE INVENTION

An object of the invention is to provide a cartridge that maintains fluids in a sealed manner.

Another object of the present invention is to provide a cartridge configured to remove sample directly from a sample container by removing the stopper of the sample container without pulling the stopper and the sample container body apart.

A further object of the present invention is to provide a cartridge that has an optical read area with a compliance to provide for correct registration of the optical read area relative to a detection device when the cartridge is positioned at the detection device.

Yet another object of the present invention is to provide a cartridge with at least one chamber that provides turbulent flow.

Still another object of the present invention is to provide a cartridge that creates metered flow of sample.

Another object of the present invention is to provide a cartridge that creates a gap which separates sample and buffer.

These and other objects of the present invention are achieved in, a cartridge for receiving a sample. An input port receives a sample from a sample container. A first chamber is in fluid communication with the input port. A flop cell is in fluid communication with the first chamber. The flow cell contains at least one reagent. A pressure port is configured to be coupled to a pressure source. A vent port is provided. The cartridge is configured to maintain fluids in a sealed manner. A first sensor is positioned adjacent to the vent port. A second sensor is positioned adjacent to the flow cell. The first sensor provides an aliquot of sample to the first chamber, and the second sensor provides a control of fluid flow through the flow cell.

In another embodiment of the present invention, a cartridge includes an inflow and an outflow port configured to receive a sample container with a stopper and a sample container body. The inflow and outflow ports are configured to remove sample directly from the sample container by removing the stopper of the sample container without pulling the stopper and the sample container body apart. A first chamber is in fluid communication with the inflow port. A flow cell is in fluid communication with the first chamber. The flow cell contains at least one reagent. A pressure port is configured to be coupled to a pressure source. A vent port is included.

In another embodiment of the present invention, a cartridge has inflow and outflow ports. A first chamber is in fluid communication with the inflow port. A flow cell is in fluid communication with the first chamber. The flow cell contains at least one reagent. A pressure port is configured to be coupled to a pressure source. A vent port and an optical read area are provided. The optical read area has a compliance to provide for correct registration of the optical read area relative to a detection device when the cartridge is positioned at the detection device.

In another embodiment of the present invention, a cartridge has inflow and outflow ports, a first chamber in fluid communication with the inflow port and a flow cell in fluid communication with the first chamber. The flow cell contains at least one reagent provides turbulent flow. A pressure port is provided and configured to be coupled to a pressure source. A vent port is also provided.

In another embodiment of the present invention, a cartridge has inflow and outflow ports, a first chamber in fluid communication with the inflow port and a flow cell in fluid communication with the first chamber. The flow cell contains at least one reagent provides turbulent flow. A pressure port is provided and configured to be coupled to a pressure source. Sample and buffer vent ports are provided. Sample is metered to provide for a gap that separates sample and buffer.

In another embodiment of the present invention, a method is provided for performing a diagnostic assay of a biological sample. A cartridge receives the sample and includes a first chamber coupled to a flow cell. A first sensor is used to provide an aliquot of the sample to the first chamber. A second sensor is used to provide a control of fluid flow through the flow cell.

### BRIEF DESCRIPTION OF THE DRAWINGS

FIG. 1 is a schematic diagram of one embodiment of a cartridge of the present invention.

FIG. 2a-c is a schematic diagram of another embodiment of a cartridge of the present invention.

FIG. 3a-b is a schematic diagram of another embodiment of a cartridge of the present invention.

FIG. 4a-d is a schematic diagram of another embodiment of a cartridge of the present invention.

FIG. 5a-b is a schematic diagram of another embodiment of a cartridge of the present invention.

### DETAILED DESCRIPTION OF THE EMBODIMENTS

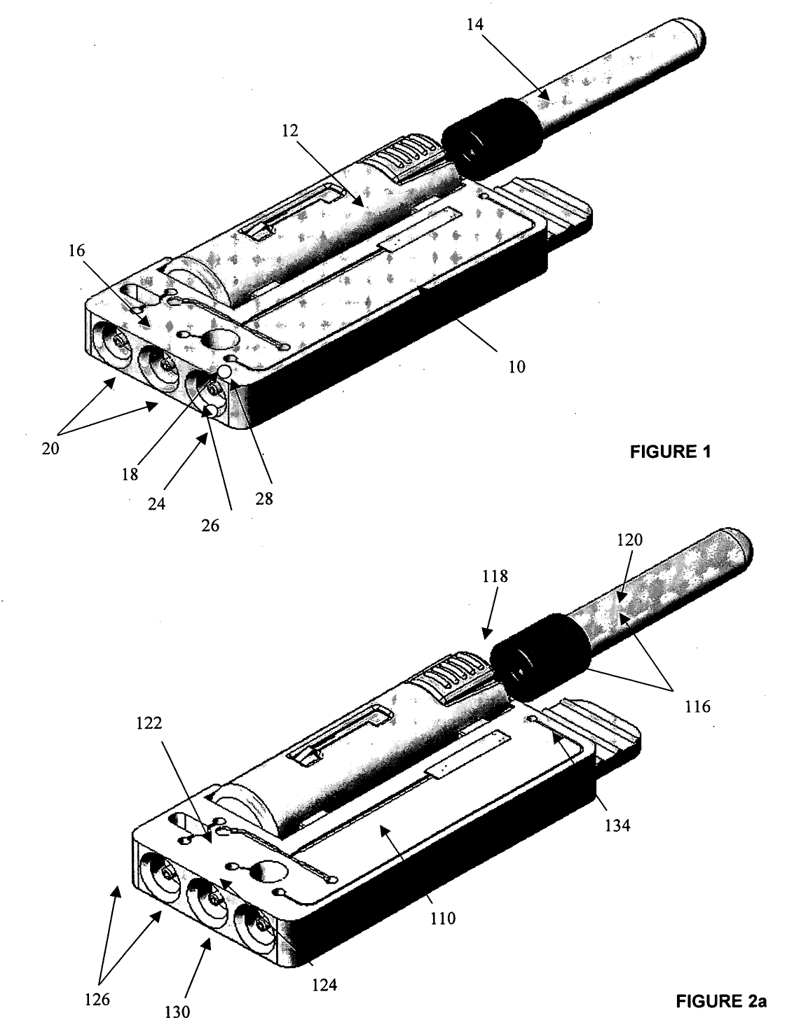

As illustrated in FIG. 1, in one embodiment of the present invention, a cartridge 10 is provided for receiving a sample, including but not limited to blood, urine, and the like. The cartridge 10 includes an input port or dock 12 for receiving a sample from a sample container 14. A first chamber 16 is in fluid communication with the input port 12. A flow cell 18 is in fluid communication with the first chamber 16. The flow cell 18 contains at least one reagent. The reagent can be a calibrant, a fluid containing reactant, a fluid not containing a reactant, a sample, and the like. A pressure port 20 is configured to be coupled to a pressure source 22, including but not limited to a syringe pump, and the like. A vent port 24 is also provided. The cartridge 10 is configured to maintain fluids in a sealed manner. In one embodiment, the sample container 14 is configured to be removed without pulling the stopper and the sample container body apart by use of a tube extractor. After the sample container is removed, the tube extractor can remain in an extended position.

A first sensor 26 is positioned adjacent to the vent port. A second sensor 28 is positioned adjacent to the flow cell 18. The first sensor 26 provides an aliquot of sample to the first chamber 16, and the second sensor 28 provides a control of fluid flow through the flow cell 18. The second sensor 28 modifies pressure to control the fluid flow throw the flow cell 18. The sensors 26 and 28 can be a variety of types, including but not limited to a, photo sensor, charge coupled device, photo detector or array, PMT, CMOS, and the like. The sensors 26 and 28 can be coupled to a digital image processing circuit. The sensors 26 and 28 can be used to detect changes of the sample in the flow cell 18 such as optical, electrical, mechanical changes and the like. Such optical changes include but are not limited to, light reflection characteristics, light absorption characteristics, and light fluorescence characteristics. Electrical changes include but are not limited to conductance, capacitance, impedance, magnetic disturbances, and the like. The sensors 26 and 28 can be a charge coupled device (CCD) photo detector array coupled to a digital image processing circuit, and include a light beam focusing lens in front of the CCD photo detectors.

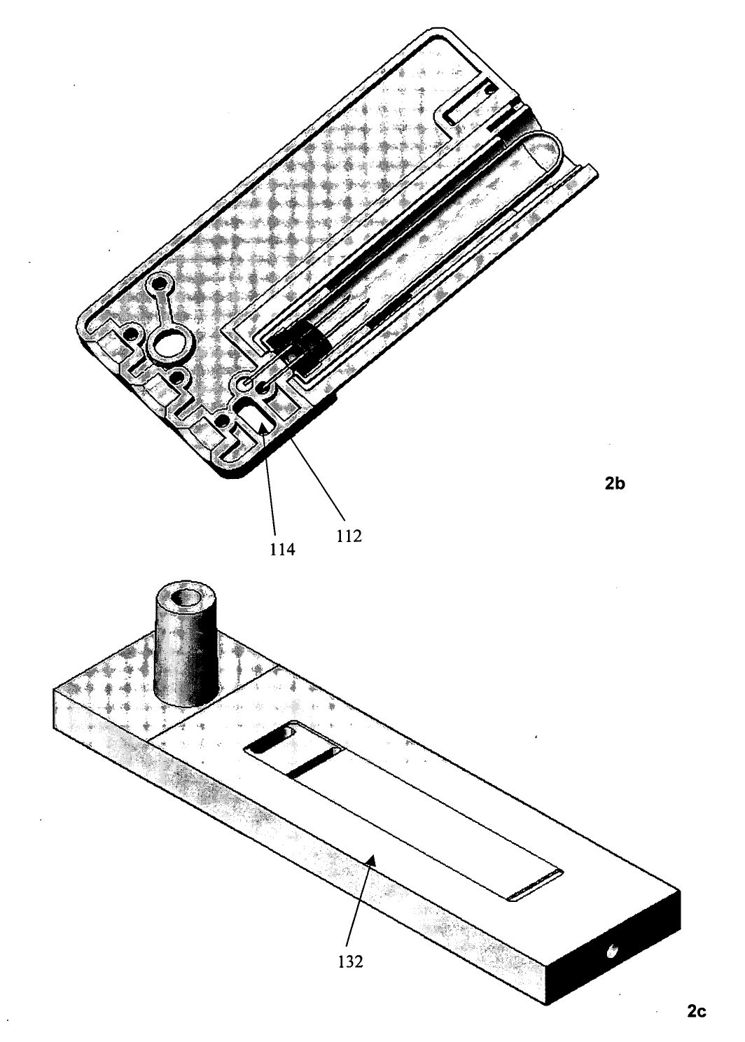

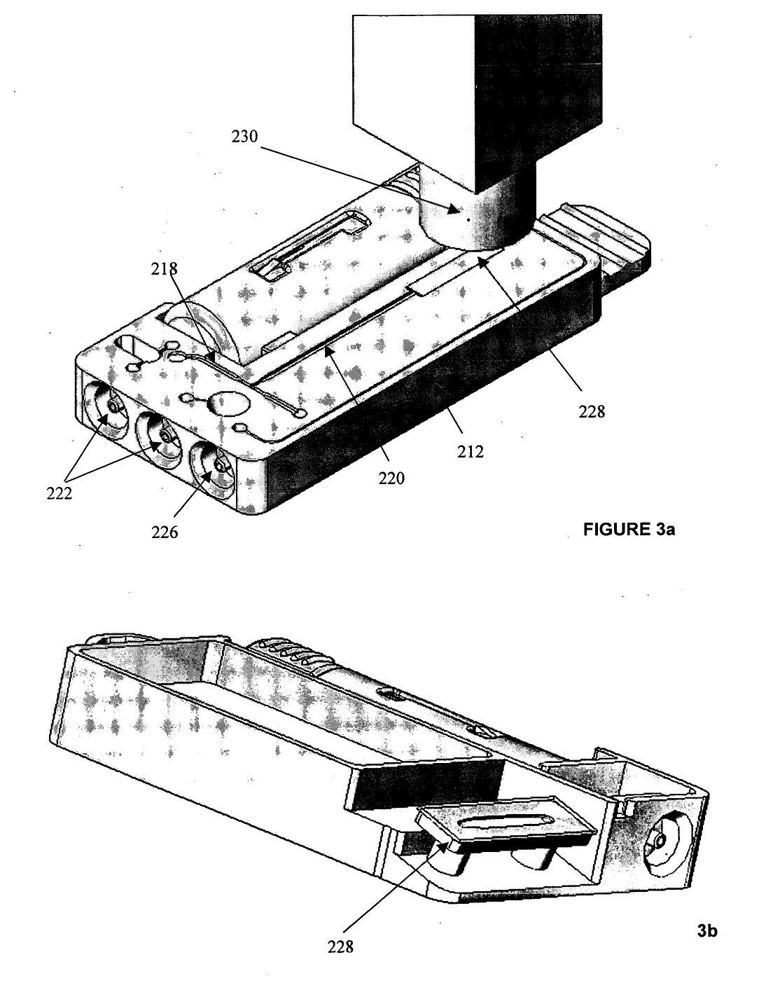

Referring now to FIGS. 2a-c, a cartridge 110 includes inflow and outflow ports 112 and 114, respectively, that are configured to receive a sample container 116 with a stopper 118 and a sample container body 120. The inflow and outflow ports 112 and 114 are configured to remove sample directly from the sample container 116 by removing the stopper 118 without pulling the stopper 118 and the sample container body 120 apart. The stopper 118 is removed while the sample container body 120 is pulled along with the stopper 118. During removal of the sample for the sample container 116, the stopper 118 and not the sample container body 120 has substantially all of applied friction incurred due to sample removal from the sample container 116.

A first chamber 122 is in fluid communication with the inflow port 112. A flow cell 124 is in fluid communication with the first chamber 122. The flow cell 124 contains at least one reagent. A pressure port 126 is provided and configured to be coupled to a pressure source 128, which again can be a syringe pump and the like. A vent port 130 is provided.

The cartridge 110 directly removes sample from the sample container 116.

The vent port 130 includes a material that minimizes passage of liquid. The vent port 130 can include a hydrophobic material. A body of the cartridge 110 can include a laminar element 132 and a molded element 134. The laminar element 132 and the molded element 134 provide a sufficient cartridge body thickness for reagent storage and mixing.

The cartridge 112 has sufficient dimensions to permit insertion and removal of the sample container 116. The sample container 116 can be a blood tube. In one embodiment, the cartridge 110 provides for isolation of dry and wet components.

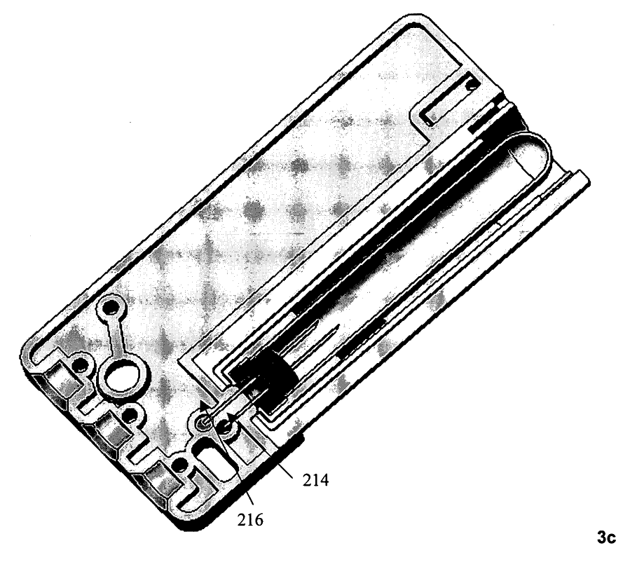

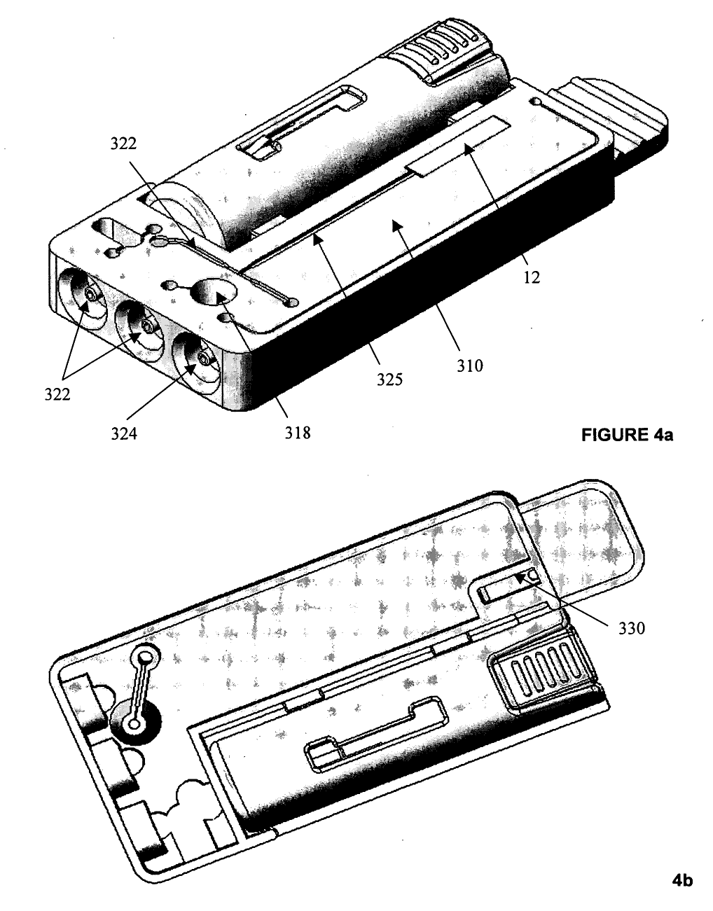

In another embodiment, illustrated in FIGS. 3a-b, a cartridge 212 includes an inflow and an outflow port 214 and 216. A first chamber 218 in fluid communication with the inflow port 214. A flow cell 220 in fluid communication with the first chamber 218. The flow cell 220 contains at least one reagent. A pressure port 222 is configured to be coupled to a pressure source 224, which again can be a syringe pump. A vent port 226 is included. An optical read area 228 has a compliance to provide for correct registration of the optical read area 228 relative to a detection device 230 when the cartridge is positioned at the detection device.

In another embodiment, illustrated in FIGS. 4a-d, a cartridge 310 includes inflow and outflow port 312 and 314. A first chamber 316 in fluid communication with the inflow port 312. A flow cell 318 is in fluid communication with the first chamber 316. The flow cell 318 contains at least one reagent. The flow cell 318 is configured to provide turbulent flow. A pressure port 320 is configured to be coupled to a pressure source 322. A vent port 324 is provided. A flow channel 324 provides a control variation of no more than <10% in flow.

A fluid moving source 326 is included that provides fluid movement by at least one of, pumping, gravity, centrifugal force and pneumatic. The flow cell 318 provides at least partial blockage of flow in the flow path of a fluid. The flow cell 318 can be a vortex. The flow cell 318 can include at least one reactive binding partner, including but not limited to an antibody and the like. The reactive binding partner can be any material that can specifically bind an analyte directly or indirectly.

The reactive antibody can be present on a surface of flow cell 12, in a flow path of flow cell 12 (which can be in the form of on a membrane, on particles immobilized in the flow path, and the like. The reactive binding partner can immobilized in a flow path. For optical detection ease, one or more dyes can be included and mixed with the reactive binding partner. Electrical and other means of sensing can be aided with other non-interfering additives. The inclusion of dye base line image data with different characteristics can be utilized. By way of illustration, and without limitation, the different characteristics can be different in intensity, frequency, magnetic field or other measurable property.

A sample overflow chamber 330 receives fluid that has flowed through the area with immobilized antibody. The sample overflow chamber 330 is coupled to the flow cell 318.

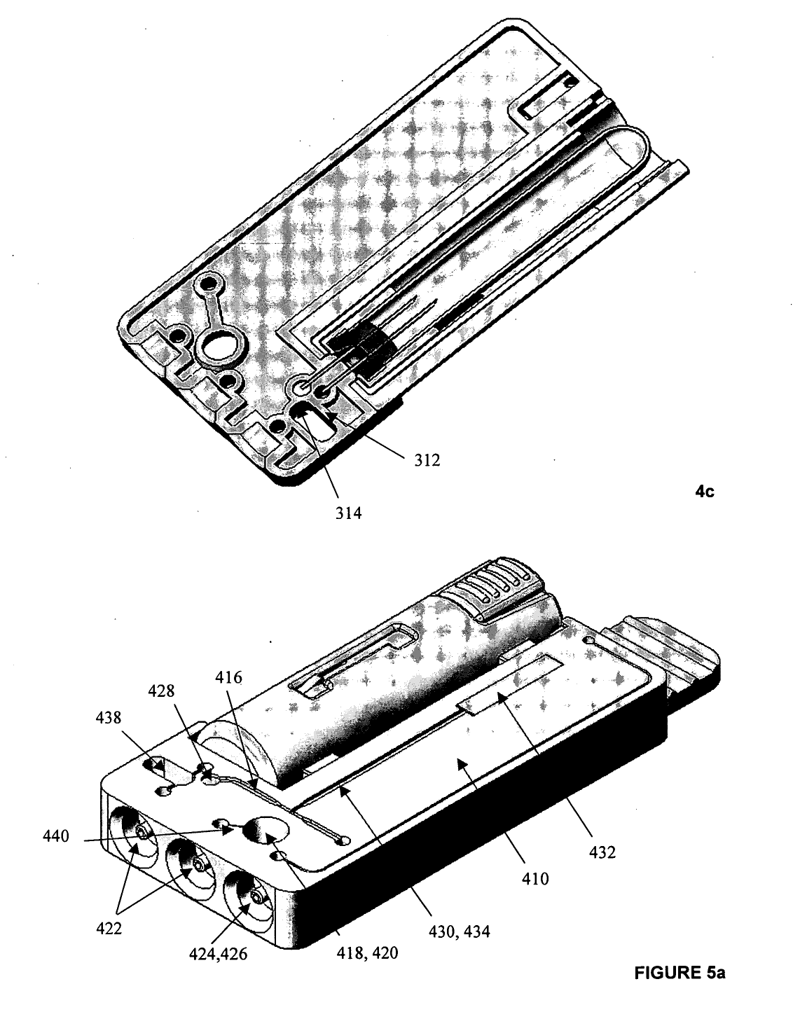

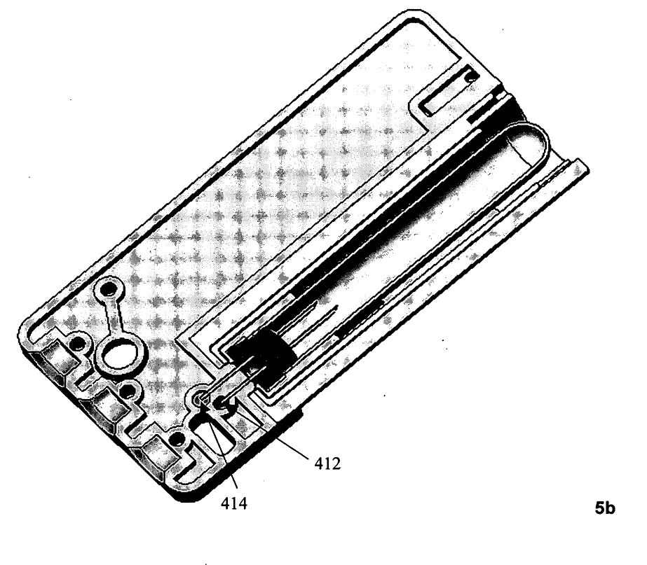

In another embodiment of the present invention, illustrated in FIG. 5a-b, a cartridge 410 includes inflow and an outflow ports 412 and 414. A first chamber 416 is in fluid communication with the inflow port 412. A flow cell 418 is in fluid communication with the first chamber 416. The flow cell 418 contains at least one reagent and is configured to provide turbulent flow. A buffer chamber 420 is provided. A pressure port 422 is configured to be coupled to a pressure source 424. A sample vent port 424 and a buffer vent port 426 are also provided. Sample is metered to provide for a gap that separates sample and buffer. The gap can be an air gap. In one embodiment, the air gap is 5 to 200 microliters.

The inflow port 412 is in line with a sample container. A syringe pump can be provided and configured to create pressure in a sample container and advance material out of the sample container and into the cartridge 410.

In one embodiment, a whole blood filter 428 is included and passes plasma into a metered flow channel 430. A multi-layer matrix 432 can be included. The multi-layer matrix 432 can include a non-permeable layer, a seal layer and a bibulous layer positioned between the non-permeable layer and the seal layer. A double sided adhesive can be on a top surface of the seal layer. At least one access port extends through the seal layer to the bibulous layer.

Cartridge 410 can include a precision flow chamber 434 that mixes conjugate and sample. Flow into the precision flow chamber 434 is by non-capillary action. By way of illustration, and without limitation, pressure is vented from precision flow chamber 434 to provide the flow into the precision flow chamber 434. In one embodiment, a solenoid valve 436 provides substantially instantaneously flow stoppage.

An overflow chamber 438 limits a reverse flow in the precision flow chamber 434. The overflow chamber 438 provides for a reduction of contamination in the cartridge 410. A passive gate 440 can be provided and coupled to the buffer chamber 420 and is configured to limit flow to a non-selected area of the cartridge 410.

Cartridges 10, 110, 210, 310 and 410, are collectively called a cartridge 510. All cartridges can include the sensors 26 and 28.

### EXAMPLE 1

In this example, cartridges 510 includes a measurement chamber, the same as the flow cell. A monitor device directly monitors and produces a signal indicative of an introduction and an exit of at least one of a sample or a reagent to and from the measurement chamber. Logic resources receive the signal and performs a comparison of a timing of the introduction and the exit of the sample to and from the measurement chamber. This produces a confirmation of a point in time of a valid reaction of the sample in the measurement chamber. The validity of the reaction is defined by the juxtapositioning of two or more reagents in a timeframe that has been determined to be sufficient for full and complete reaction.

### EXAMPLE 2

In this example, the sample is introduced into cartridge 510 by a variety of means including but not limited to, laminar flow, absorption, with the use of a pumping force (displacement, either positive or negative pressure) gravity, centrifugal force, pneumatic movement, and the like. A variety of sensors can be utilized, including but not limited to a, photo sensor, charge coupled device, photo detector or array, PMT, CMOS, and the like. The sensor is coupled to a digital image processing circuit. The sensor is used to detect changes of the sample in the measurement chamber. Such optical changes include but are not limited to, light reflection characteristics, light absorption characteristics, and light fluorescence characteristics. Electrical changes include but are not limited to conductance, capacitance, impedance, magnetic disturbances, and the like. The sensor can be a charge coupled device (CCD) photo detector array coupled to a digital image processing circuit, and include a light beam focusing lens in front of the CCD photo detectors.

### EXAMPLE 3

In this example, an energy source produces an output of energy that interacts with the measurement chamber. The sensor is positioned to receive an output that can be light intensity, a measurement of wavelength, a measurement of electric capacitance, a measurement of conductivity, impedance and/or magnetic field, and the like. A monitor device can include the energy source and/or the sensor. The monitor device can directly monitor a progress of events inside the measurement chamber. This progress of events in the measurement chamber includes but is not limited to, sample introduction, calibrant introduction, sample wash out, calibrant displacement, reagent introduction, and the like.

### EXAMPLE 4

In this example, the monitor device provides an indication of a response of the sample to a mechanical change. Such a mechanical change can include, but is not limited to, movement of a pump to create a flow of sample or reagent, pneumatic movement, movement of a reaction area in the measurement chamber, movement of the measurement chamber, a mechanical response relative to a secondary reaction in the measurement chamber, sensing of a fluid entrance or displacement in the measurement chamber and the like.

### EXAMPLE 5

In this example, the monitor device detects changes in the measurement chamber and in response to the changes, determines if there is a sufficient amount of at least one of sample, reagent or calibrant in the measurement chamber.

### EXAMPLE 6

In this example, measurement chamber is a solid phase label mixing chamber with or without a matrix. The matrix can contain labeled reagent for binding with the sample. The binding agent can be on the chamber wall or in the matrix which may be a glass fiber structure. Glass fiber is used for the immobilized, solid phase antibody. The glass fiber allows the use of a larger surface area and it may be easier to force the sample through that type of structure. The fluid contact can be extended by stopping the flow or mixing enhanced by increasing the rate or flow through a tortuous path in order to maximize sample/label mixing interaction.

### EXAMPLE 7

In this example, the cartridge 510 includes a precision dimensioned flow channel that receives fluid from the measurement chamber at a rate a rate precisely controlled by force applied by the fluid moving source which can be speed. Precision control results in less than a 10% variation in flow rate and thus a transit time through the precision flow channel based on pumping mechanism control, Precision control can be achieved with devices and schemes that control the flow rate, the force that is applied to a fluid, and the like. The flow channel leads to a flow control chamber. From the flow control chamber, fluid sample flows into an immobilized antibody matrix. The matrix is coupled to a sample overflow chamber. A vent is used to provide suction to draw or pull fluid so that it flows through the cartridge 510. A clear film window covers the precision flow channel and the matrix. The clear window allows for fluorescence or other indicator from the matrix to be detected. Other indicators utilized can include, but are not limited to, color, magnetic property change, chemi-luminescence and the like.

### EXAMPLE 8

In this example, labeled antibody is thoroughly mixed with the sample using precision pumped flow through a mixing matrix. The resulting mixture is pumped to a flow channel wherein flows under the control of a fluid moving source at a precise rate so as to control binding of the analyte contained in the sample with the labeled antibody.

### EXAMPLE 9

In this example, fluid flows rapidly into the mixing chamber and flows slower in the measurement chamber itself. The fluid flowing through the precision flow channel is the time when the antigen in the sample is binding to the labeled antibody. This is controlled precisely to allow for adequate incubation time. It flows at a very slow rate through the precision flow channel. The flow rate is about 2-15 ul/sec

### EXAMPLE 10

In this example, upon exiting the precision flow channel, the mixture is forced by the fluid moving source into a chamber where further mixing occurs due to turbulent flow to assure homogeneity. The chamber is constructed in such a way to force the flow of the reacted mixture into the measurement chamber which contains an immobilized antibody on a high surface area matrix. The reacted mixture flows through the matrix in intimate contact with materials therein, such as but not limited to immobilized antibody. The analyte in the sample which has bound to the labeled antibody during the precision flow step, additionally becomes bound to the immobilized antibody. Further sample, essentially free from any labeled material is then forced through the matrix to reduce any non-specific binding in a fluorescence zone. Excess mixed and unmixed sample is moved, such as by pumping action, into an empty sample overflow chamber.

### EXAMPLE 11

In this example, after the mixed sample/label flows past an immobilized antibody chamber, a wash buffer is introduced to remove sample/label completely and by so doing reduce background interferences. Alternatively, the sample flows directly into the immobilized the immobilized antibody chamber through a direct injection port. A buffer is pumped through a label mixing chamber and carries the label through a label injection port into the immobilized antibody chamber.

The foregoing description of various embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A cartridge for receiving a sample, comprising:
an input port for receiving a sample from a sample container;
a first chamber in fluid communication with the input port;
a flow cell in fluid communication with the first chamber;
a pressure port configured to be coupled to a pressure source;
a vent port, wherein the cartridge is configured to maintain fluids in a sealed manner; and
a first sensor positioned adjacent to the vent port and a second sensor positioned adjacent to the flow cell, the first sensor providing an aliquot of sample to the first chamber, and the second sensor configured to provide a control of fluid flow through the flow cell.

2. The cartridge of claim 1, wherein the second sensor modifies pressure to control the fluid flow throw the flow cell.

3. The cartridge of claim 1, wherein the flow cell includes at least one fluid.

4. A cartridge for receiving a sample, comprising:
an inflow and an outflow port configured to receive a sample container with a stopper and a sample container body, the inflow and outflow ports configured to remove sample directly from the sample container by application of pressure without removal of the stopper;
a first chamber in fluid communication with the inflow port;
a flow cell in fluid communication with the first chamber;
a pressure port configured to be coupled to a pressure source; and
a vent port.

5. The cartridge of claim 4, wherein the sample container is configured to be removed without pulling the stopper and the sample container body apart by use of a tube extractor.

6. The cartridge of claim 5, wherein after the sample container is removed, the tube extractor remains in an extended position.

7. The cartridge of claim 4, further comprising:
a first sensor positioned adjacent to the vent port and a second sensor positioned adjacent to the flow cell, the first sensor providing an aliquot of sample to the first chamber, and the second sensor configured to provide a control of fluid flow through the flow cell.

8. The cartridge of claim 4, wherein the stopper is removed while the sample container body is pulled along with the stopper;

9. The cartridge of claim 4, wherein during removal of the sample for the sample container, the stopper and not the sample container body has substantially all of applied friction incurred due to sample removal from the sample container.

10. The cartridge of claim 4, wherein the cartridge directly removes sample from the sample container.

11. The cartridge of claim 4, wherein the vent port includes a material that minimizes passage of liquid.

12. The cartridge of claim 4, wherein the vent port includes a hydrophobic material.

13. The cartridge of claim 4, wherein a body of the cartridge includes a laminar element and a molded element.

14. The cartridge of claim 13, wherein the laminar element and molded element provide a sufficient cartridge body thickness for reagent storage and mixing.

15. The cartridge of claim 4, wherein the cartridge has sufficient dimensions to permit insertion and removal of the sample container.

16. The cartridge of claim 11, wherein the sample container is a blood tube.

17. The cartridge of claim 4, wherein the cartridge provides for isolation of dry and wet components.

18. A cartridge for receiving a sample, comprising:
an inflow and an outflow port
a first chamber in fluid communication with the inflow port;
a flow cell in fluid communication with the first chamber;
a pressure port configured to be coupled to a pressure source;
a vent port; and
an optical read area, the optical read area having a compliance to provide for correct registration of the optical read area relative to a detection device when the cartridge is positioned at the detection device.

19. The cartridge of claim 18, further comprising:
a first sensor positioned adjacent to the vent port and a second sensor positioned adjacent to the flow cell, the first sensor providing an aliquot of sample to the first chamber, and the second sensor configured to provide a control of fluid flow through the flow cell.

20. A cartridge for receiving a sample, comprising:
an inflow and an outflow port
a first chamber in fluid communication with the inflow port;
a flow cell in fluid communication with the first chamber, the flow cell being configured to provide turbulent flow;
a pressure port configured to be coupled to a pressure source; and
a vent port.

21. The cartridge of claim 20, further comprising:
a first sensor positioned adjacent to the vent port and a second sensor positioned adjacent to the flow cell, the first sensor providing an aliquot of sample to the first chamber, and the second sensor configured to provide a control of fluid flow through the flow cell.

22. The cartridge of claim 20, further comprising:
a flow channel that provides a control variation of no more than <10% in flow.

23. The cartridge of claim 20, further comprising:
a fluid moving source that provides fluid movement by at least one of, pumping, gravity, centrifugal force and pneumatic.

24. The cartridge of claim 20, wherein the flow cell provides at least partial blockage of flow in the flow path of a fluid.

25. The cartridge of claim 20, wherein the flow cell is a vortex.

26. The cartridge of claim 20, wherein a dry reagent is on a wall of the flow cell.

27. The cartridge of claim 19, wherein the dry agent is sprayed on the wall of the flow cell.

28. The cartridge of claim 20, wherein immobilized antibody is located in an immobilized antibody chamber.

29. The cartridge of claim 20, further comprising:
a sample overflow chamber to receive fluid that has flowed through the area with immobilized antibody, wherein the sample overflow chamber is coupled to the flow cell.

30. A cartridge for receiving a sample, comprising:
an inflow and an outflow port
a first chamber in fluid communication with the inflow port;
a flow cell in fluid communication with the first chamber, the flow cell containing at least one reagent, the flow cell being configured to provide turbulent flow;
a buffer chamber;
a pressure port configured to be coupled to a pressure source;
a sample vent port; and
a buffer vent port, wherein sample is metered to provide for a gap that separates sample and buffer.

31. The cartridge of claim 30, further comprising:
a first sensor positioned adjacent to the vent port and a second sensor positioned adjacent to the flow cell, the first sensor providing an aliquot of sample to the first chamber, and the second sensor configured to provide a control of fluid flow through the flow cell.

32. The cartridge of claim 30, wherein the gap is an air gap.

33. The cartridge of claim 30, wherein the vent port is in line with a sample container, wherein the syringe pump is configured to create pressure in the sample container and advance material out of the sample container and into the cartridge.

34. The cartridge of claim 32, further comprising:
a whole blood filter that passes plasma into a metered flow channel.

35. The cartridge of claim 30, wherein the gap is 5 to 200 microliters.

36. The cartridge of claim 30, further comprising:
a multi-layer matrix.

37. The cartridge of claim 36, wherein the multi-layer matrix includes a non-permeable layer, a seal layer and a bibulous layer positioned between the non-permeable layer and the seal layer.

38. The cartridge of claim 37, wherein the multi-layer matrix further includes a double sided adhesive on a top surface of the seal layer.

39. The cartridge of claim 37, further comprising:
at least one access port that extends through the seal layer to the bibulous layer.

40. The cartridge of claim 30, wherein a precision flow chamber mixes conjugate and sample.

41. The cartridge of claim 30, wherein flow into a precision flow chamber is by non-capillary action.

42. The cartridge of claim 41, wherein pressure is vented from flow chamber to provide the flow into the precision flow chamber.

43. The cartridge of claim 41, further comprising:
a solenoid valve that provides substantially instantaneously flow stoppage.

44. The cartridge of claim 41, further comprising:
an overflow chamber to limit a reverse flow in the precision flow chamber.

45. The cartridge of claim 44, wherein the overflow chamber provides for a reduction of contamination in the cartridge.

46. The cartridge of claim 41, further comprising:
a passive gate coupled to a buffer chamber and configured to limit flow to a non-selected area of the cartridge.

47. A method of performing a diagnostic assay of a biological sample, comprising:
providing a cartridge for receiving the sample that includes a first chamber coupled to a flow cell;
receiving the sample in the cartridge;
utilizing a first sensor to provide an aliquot of the sample to the first chamber, and
utilizing a second sensor to provide a control of fluid flow through the flow cell.

48. The method of claim 47, further comprising:
utilizing a flow channel to provide a control variation of no more than <10% in flow.

49. The method of claim 47, further comprising:
utilizing a fluid moving source to provide fluid movement in the cartridge.

50. The method of claim 49, wherein the fluid moving source is selected from at least one of, pumping, gravity, centrifugal force and pneumatic.

51. The method of claim 47, further comprising:
utilizing the flow cell to provide at least partial blockage of flow in a flow path of a fluid.

52. The method of claim 47, further comprising:
providing an immobilized antibody in the cartridge.

53. The method of claim 47, further comprising:
monitoring flow of sample in the flow cell.

54. The method of claim 47, further comprising:
confirming when a valid reaction of the sample has occurred.

55. The method of claim 47, further comprising:
determining if there is a sufficient amount of at least one of sample, reagent or a calibrant in the flow cell.

56. The method of claim 47, further comprising:
providing a matrix that can contain labeled reagent for binding with the sample.

57. The method of claim 47, further comprising:
providing precision control of flow in the cartridge.

58. The method of claim 57, wherein the precision control results in less than a 10% variation in a flow rate in the cartridge.

59. The method of claim 47, further comprising:
mixing a labeled antibody with the sample in the cartridge.

60. The method of claim 59, further comprising:
controlling binding of an analyte contained in the sample with the labeled antibody.
